(19) United States
(12) Patent Application Publication
(10) Pub. No.: US 2009/0254563 A1
(43) Pub. Date: Oct. 8, 2009

(54) METHOD AND SYSTEM FOR DYNAMICALLY CREATING AND UPDATING USER PROFILES FOR INSTANT MESSAGE CONTACTS

(76) Inventors: JEREMY A. ARNOLD, Rochester, MN (US); Scott A. Moore, Rochester, MN (US); Gregory A. Olson, Rochester, MN (US); Eric J. Stec, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 12/061,001

(22) Filed: Apr. 2, 2008

(51) Int. Cl. G06F 17/30

(52) U.S. Cl. 707/10; 707/E17.001

(57) ABSTRACT

A method, system and computer program product for enabling retrieval and display from an information resource of additional information corresponding to an instant message (IM) contact using search topics detected/retrieved from: a profile of the IM contact; a stored list of topics of interest to the IM contact; and content manually selected from the contact's IM message during an ongoing IM session. The IM contact's profile information is entered by a local user or is received from the IM contact's IM client following an exchange of self-entered profile information between a local user and the IM contact during the IM session. A searching facility, when turned on, dynamically performs the search for additional information from the content retrieved from the profile. Returned information is then visually presented to the local user to enhance the local user's knowledge of the particular topic.

### RELATED APPLICATION

The present invention is related to the subject matter of commonly assigned, related patent application, Ser. No. ______ (Atty. Doc. No. ROC920070599US1) titled “Method And System For Real-Time/Dynamic retrieval of Information Related To An On-Going Instant Message Communication”, filed on even date herewith. The content of the related application is incorporated herein by reference.

### BACKGROUND

1. Technical Field

The present invention generally relates to computer systems and in particular to messaging applications in computer systems.

2. Description of the Related Art

Instant messaging (IM) has become a very popular communication tool in business, educational, and domestic arenas. IM is a quick effective way to correspond locally or long distance with buddies, co-workers, and family members without the commitment of a phone call. Recently, IM has been increasingly utilized in corporate settings to discuss meeting agendas, ideas, frustrations, business solutions as well as leisure chatting.

Instant messaging has become a pervasive technology throughout social and business interactions. As reliance on this technology increases, finding new ways to maximize the experience and efficacy of instant message conversations becomes more important. Currently some instant messaging programs allow home users (an owner of the particular IM) to create client profiles (of IM contacts), whereby a user enters information regarding personal preferences, location, and the like, about the contact. These user-created profiles may include information relative to a person's life and useful during IM chatting. However, the profile information is not customizable by other users and may only be updated manually by the home user.

### SUMMARY OF ILLUSTRATIVE EMBODIMENTS

Disclosed are a method, system and computer program product for enabling retrieval and display from an information resource of additional information corresponding to an instant message (IM) contact using search topics detected/retrieved from: a profile of the IM contact; a stored list of topics of interest to the IM contact; and content manually selected from the contact's IM message during an ongoing IM session. The IM contact's profile information is entered by a local user or is received from the IM contact's IM client following an exchange of self-entered profile information between a local user and the IM contact during the IM session. A searching facility, when turned on, dynamically performs the search for additional information from the content retrieved from the profile. Returned information is then visually presented to the local user to enhance the local user's knowledge of the particular topic.

Another embodiment provides a method, system and computer program product for enabling retrieval and display from an information resource of additional information corresponding to topics within current, real-time communication between an instant message (IM) contact and a local user. Content is dynamically (or manually) retrieved from the contact's IM message during an ongoing IM session/communication. A searching facility, when turned on, dynamically performs the search for additional information related to the content retrieved from within the communication exchanged during the on-going IM session. Returned information is then visually presented in real-time to the local user to enhance the local user's knowledge of the particular topic.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data processing system, within which carious features of the invention may advantageously be implemented, according to one embodiment of the invention;

FIG. 2 is a diagram of a network of computers utilizing instant messaging (IM) clients in accordance with one embodiment of the invention;

FIG. 3 illustrates a graphical user interface for creating a profile for an IM contact according to one embodiment of the invention;

FIG. 4 illustrates a graphical user interface for selecting an IM contact based on a topic of discussion according to one embodiment of the invention;

FIG. 5 illustrates a graphical user interface for displaying search results based on topics of discussion within an IM conversation in accordance with one embodiment of the invention;

FIG. 6 is a logic flow chart for receiving and utilizing a contact's profile information, according to one embodiment of the invention; and

FIG. 7 is a logic flow chart for retrieving and displaying search topic results based on (a) user-inputted profile information of a contact and (b) keyword searches from real time IM conversations, in accordance with embodiments of the invention.

### DETAILED DESCRIPTION OF AN ILLUSTRATIVE EMBODIMENT

A first illustrative embodiment provides a method, system and computer program product for enabling retrieval and display from an information resource of additional information corresponding to an instant message (IM) contact using search topics detected/retrieved from: a profile of the IM contact; a stored list of topics of interest to the IM contact; and content manually selected from the contact's IM message during an ongoing IM session. The IM contact's profile information is entered by a local user or is received from the IM contact's IM client following an exchange of self-entered profile information between a local user and the IM contact during the IM session. A searching facility, when turned on, dynamically performs the search for additional information from the content retrieved from the profile. Returned information is then visually presented to the local user to enhance the local user's knowledge of the particular topic.

Another illustrative embodiment provides a method, system and computer program product for enabling retrieval and display from an information resource of additional information corresponding to topics within current, real-time communication between an instant message (IM) contact and a local user. Content is dynamically (or manually) retrieved from the contact's IM message during an ongoing IM session/communication. A searching facility, when turned on, dynamically performs the search for additional information related to the content retrieved from within the communication exchanged during the on-going IM session. Returned information is then visually presented in real-time to the local user to enhance the local user's knowledge of the particular topic.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

The specific numerals assigned to the elements are provided solely to aid in the description and not meant to imply any limitations (structural or functional) on the invention. It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the terms “conversation” describes the dialogue during an IM session and “content” describes a proper noun utilized within the IM conversation.

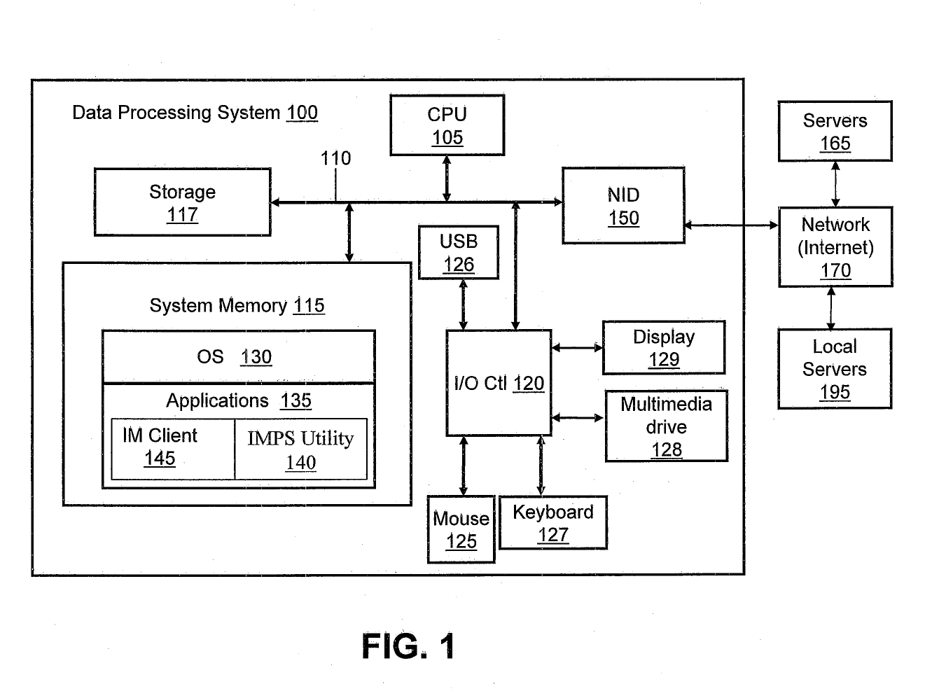

With reference now to FIG. 1 there is depicted a block diagram representation of a data processing system (and connected network). DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVD drive) and USB (universal serial bus) port 126 are illustrated, coupled to I/O controller. DPS 100 also comprises storage 117, within which data/instructions/code may be stored.

DPS 100 is also illustrated with a network interface device (NID) 150, with which DPS 100 connects to local server 195 and one or more remote servers 165 via an access network, such as the Internet 170. In the described embodiments, Internet 170 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example.

Notably, in addition to the above described hardware components of DPS 100, various features of the invention are completed via software (or firmware) code or logic stored within system memory 115 or other storage (e.g., storage 117) and executed by CPU 105. Thus, illustrated within system memory 115 are a number of software/firmware components, including operating system (OS) 130 (e.g., Microsoft Windows®, a trademark of Microsoft Corp, GNU®/Linux®, registered trademarks of the Free Software Foundation and The Linux Mark Institute, or AIX®, a registered trademark of IBM), applications 135, including instant messaging (IM) client 145, and instant messaging profile supplementing (IMPS) utility 140. In actual implementation, IM client 145, and IMPS utility 140 may be combined as a single application collectively providing the various functions of each individual software component when the corresponding code is executed by the CPU 105. For simplicity, IMPS utility 140 is illustrated and described as a stand alone or separate software/firmware component, which provides specific functions within the IM client 145, as described below.

CPU 105 executes IM client 145, IMPS utility 140, as well as OS 130, which supports the user interface features of IMPS utility 140 within IM client 145. In the illustrative embodiment, IMPS utility 140 provides several graphical user interfaces (GUIs) to enable user interaction with, or manipulation of, the functional features of the IM client (145) and the IMPS utility (140). Among the software code/instructions provided by IMPS utility 140, and which are specific to the invention, are: (a) code for enabling a passing and receiving of user profile information for contacts within a home user's IM client; (b) code for retrieving/detecting content within an IM contact's profile; (c) code for dynamically searching for additional information related to the content when the content detected provides an appropriate search topic; and (d) code for displaying results, in a graphical user interface, from one or more search topics corresponding to the detected content.

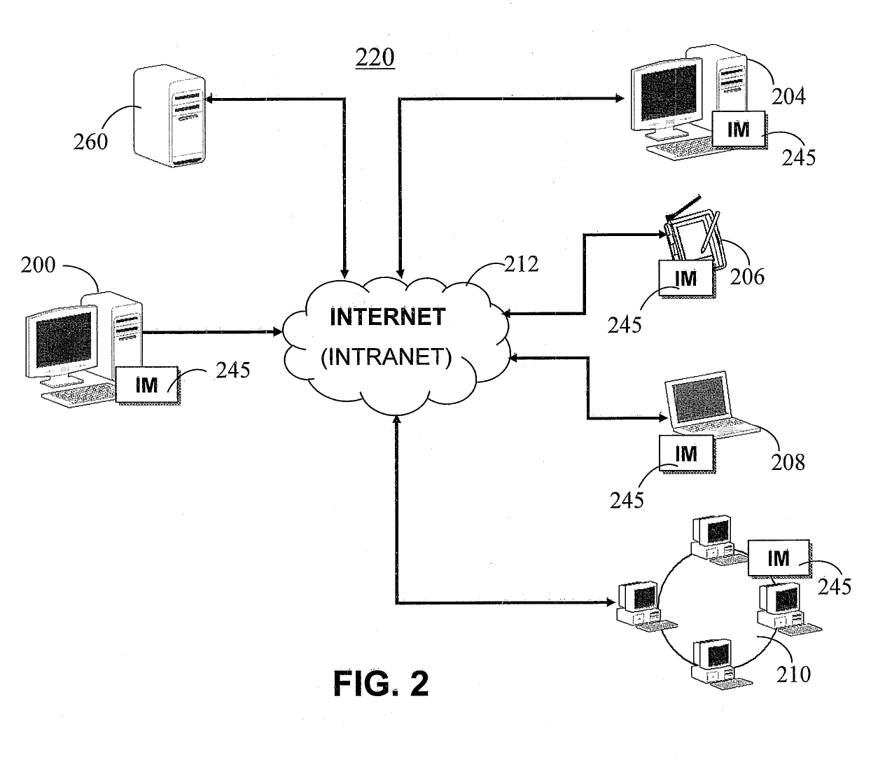

In another embodiment, the IMPS utility further comprises: (d) code for automatically detecting keywords/terms within an ongoing IM conversation; code for dynamically initiating a search in real-time for information related to the detected keywords/terms; and code for displaying the found information related to the detected keywords/terms within a GUI associated with the IM client. For simplicity of the description, the collective body of code that enables the above-listed features is referred to herein as IMPS utility 140. According to the illustrative embodiment, when CPU 105 executes IMPS utility 140, DPS 100 (and IM client 145) initiates a series of functional processes that enable the above functional features as well as additional features/functionality, which are described below within the description of FIGS. 2-7.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2 which illustrates a network of computers that are capable of communicating in real-time via respective IM clients 245 (similar to IM client 145 of FIG. 1). Several computer systems and/or computer-type devices may exist in network 220, including computer 200, desktop computer 204, handheld computer 206, laptop 208, community computers 210, and host server 260. Host server 260 may be a located within a community of computers within network 220. Host server 260 may be a local or remote machine utilized to store IM client profiles and information relative to search topics. Computer 200 communicates with each other computer/device in network 220 utilizing IM client 245 via Internet 212. IM client 245 may be utilized to send and receive messages instantly to one or more computers within network 220 via the Internet or an Intranet.

Community computers 210 are a community of networked computers utilized in a corporate setting for collaboration purposes. The corporate setting may be for educational, business, or leisure purposes. During IM communication, content within the contact's profiles and/or an ongoing IM conversation on computer 200 is dynamically retrieved by IMPS utility (140). The content is then utilized as a topic to perform a search on Internet 212. Retrieved information associated with the content is displayed on a graphical user interface (GUI). The information may be a URL, editorial, commentary, photograph, illustration, and/or any other content.

In one embodiment, the IM user on computer 200 has IM contacts on desktop computer 204, handheld computer 206, laptop computer 208, and community computers 210. In one embodiment, the operator of computer 200 desires to participate in an IM session, and conducts a conversation/chat in which content related to a specific topic is exchanged. With certain permissions set by the user on the IM client 145, the IM contact's profile and/or ongoing IM sessions (conversations) are dynamically searched for content (e.g., keywords/terms) to identify a topic that is searched over the connected network (e.g., Internet). In some implementations, the searched topic may be a specific topic that is most related to a topic of interest to the IM user on computer 200.

Notably, while illustrated and described as a network of computers, it is appreciated that the embodiments are also applicable to other types of devices that include IM clients and which support IM conversations. Among these devices are smart phones, personal digital assistants, and other personal computing/communication devices, among others. Thus, the description of specific types of devices within the embodiments is not meant to impose any limitations on the invention.

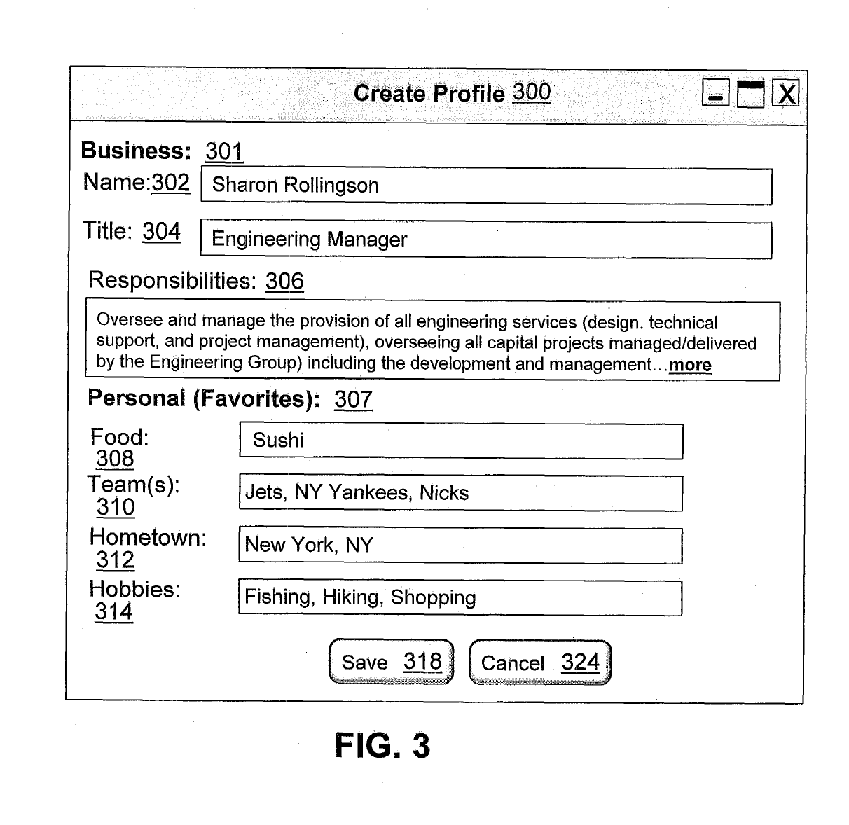

FIG. 3 illustrates create profile GUI 300. Create profile GUI 300 comprises business profile 301 and personal profile 307. Create profile GUI 300 allows an IM user (also referred to herein as a home user) to create a profile for the home user and/or for an IM contact. In one embodiment the IM user inputs information relative to a contact. The information relative to the contact may be input into business profile 301 and/or personal profile 307. Within business profile 301 are name entry 302, title entry 304, and responsibilities entry 306. Within personal profile 307 are food entry 308, team(s) entry 310, hometown entry 312, and hobbies entry 314. Other entries may be utilized to describe the profile of the contact (e.g. favorite car, pet, store, restaurant, brand, etc.), and the illustrated list is presented solely as a representative set of the types of entries that may be provided. Information added to create profile GUI 300 is stored utilizing save button 318. Cancel button 324 may allow a user to exit from create profile GUI 300 without saving any modified information.

In one embodiment, during an IM conversation with a contact, the profile of the contact is dynamically searched by IMPS utility 140. certain content provided within the entries within the business profile 301 and/or personal profile 307 is utilized as search topics during the IM conversation with the contact. For example, in one embodiment, proper names, nouns, as well as job-related topics may be utilized to retrieve information from a network and/or database, to which the computer system (200) executing the IM client and IMPS utility is communicatively connected. Results returned from the search of content retrieved from hometown entry 312 may yield information such as recent news, weather, and events related to the entered hometown (or city or state).

In one embodiment, the IMPS utility performs a dynamic update of the stored IM contacts' profiles with additional information. The additional information is information that is (a) derived from an IM session with the contact and/or (b) selectively stored from information retrieved from a search of topics of interest (with the topics selected from the contact's profile). The update to the IM contacts' profiles enables the local user to have more up-to-date information or information of interest to the IM contact(s), which information the local user may utilized during a subsequent IM session with the IM contact(s). Updates may continue to occur in the background while the local user's the IM client is running and the computer system (200) is connected to the network.

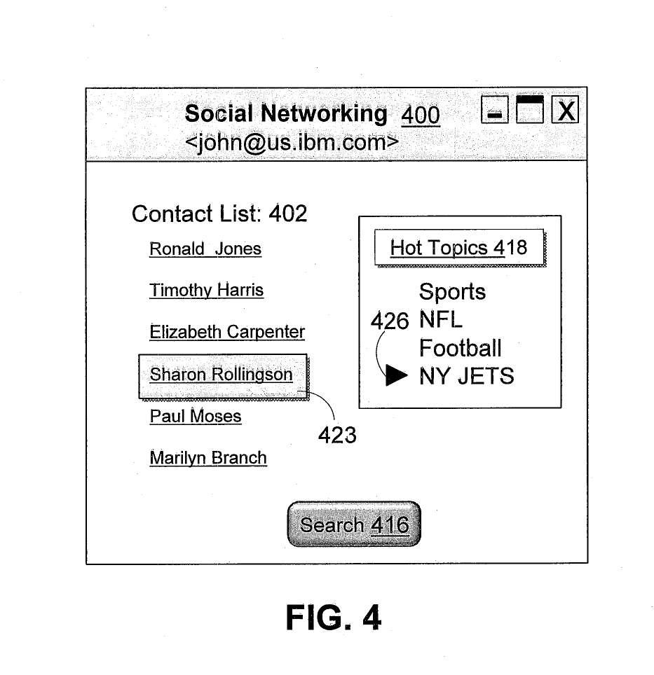

FIG. 4 illustrates an example social networking GUI 400, which is utilized to select IM contacts to participate in an online chat. Contact list 402 comprises a list of stored contacts, of which presently-selected contact 423 is highlighted. Once a contact is selected from among contact list 402, hot topics 418 generates a list of topics in which the selected contact (423) is interested. The IM user selects one of the provided hot topics 418 associated with the selected contact 423 as a select topic 426. The user then selects the search button 416, which triggers the IMPS utility to initiate retrieval of information specific to the selected topic 426 in order to enable the IM user to engage in a more interesting conversation with the selected contact 423. Also, the IM user is able to select a topic of conversation which actually interests the IM user.

In some instances an individual may have the desire to chat about a topic with any one or more contacts from contact list 402. In another embodiment, hot topics 418 are example subjects of interest to an IM user. The IM user may select a subject from hot topics 418, such as selected topic 426, which becomes the subject of interest for chatting. When search button 416 is selected, IMPS utility 140 dynamically searches previous or current conversations of individuals within contact list 402 to identify one or more conversations which mention or have mentioned selected topic 426 within the IM sessions.

In one embodiment, when selected topic 426 is identified among the current IM sessions, the one or more contacts with whom the subject is discussed is identified by IMPS utility 140. IMPS utility 140 may identify selected contact 423 utilizing an action such as highlighting, blinking, italicizing, bolding, and/or underlining the one or more contacts. With this embodiment, the local IM user and all social networking contacts are provided the ability to disable this function (i.e., the ability to dynamically search a conversation) within their respective IM clients.

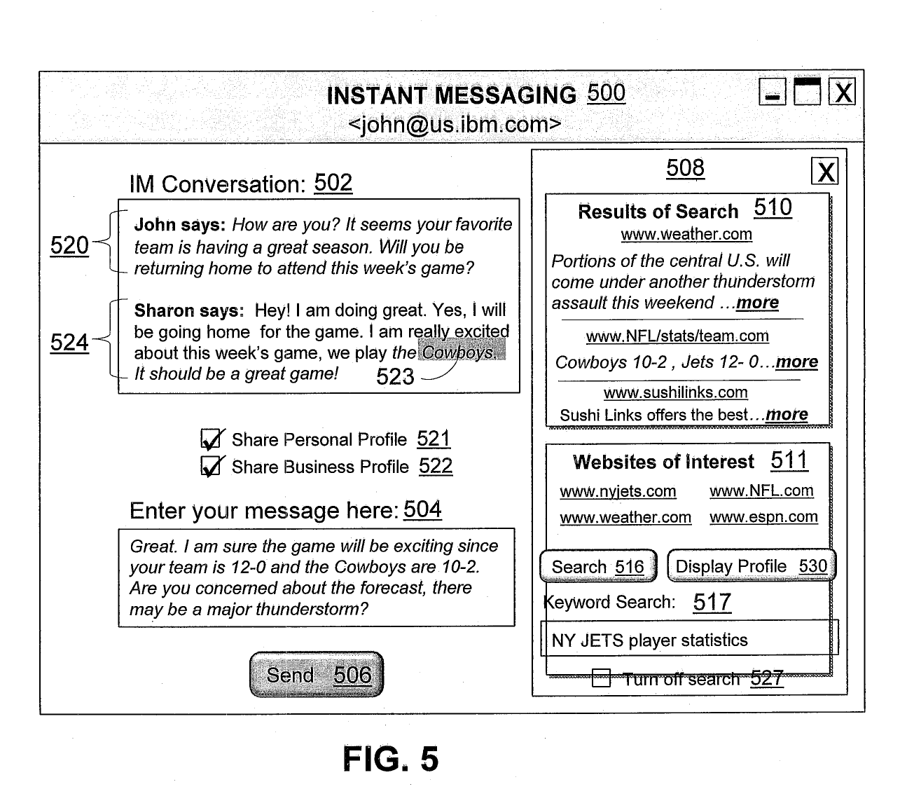

FIG. 5 depicts IM graphical user interface (GUI) 500. IM GUI 500 comprises IM conversation 502, IM message entry 504, and IM send button 506. Send button 506 is utilized to send content entered into IM message entry 504. Within IM conversation 502 is the conversation of local (home) user 520 and remote user 524, which conversation provides content that includes selected text 523.

IM GUI 500 also comprises user-selectable options of share personal profile 521 and share business profile 522, which may be selected, when the user desires to upload the IM user's profile to the one or more IM contacts participating in the current IM session.

As provided by the illustrative embodiment, IM GUI 500 also comprises search toolbox 508, which includes results of search 510, websites of interest 511, search web button 516, display profile button 530, and keyword search entry 517. Also within search toolbox 508, IM GUI 500 includes turn off search option 527. Turn off search option 527 allows the search activity within search toolbox 508 to be temporarily suspended and/or closed.

In one embodiment, search toolbox 508 displays results of search 510 and websites of interest 511. Results of search 510 comprise a brief synopsis of an article received from a retrieved website, which may be provided as a hotlink to enable the local user to open a browser and view the entire content of the webpage. Results of search 510 may display news clippings, photographs, illustrations, and the like, which are relative to a topic within IM conversation 502. Sites of interest 511 automatically display websites that are related to one or more topics discussed in IM conversation 502 or websites related to keywords/terms detected within the contact's profile. Keyword search entry 517 allows a topic to be entered manually for an immediate search while participating in an IM conversation.

According to the described embodiments, IM GUI 500 (and specifically search toolbox 508) allows the content of IM conversation 502 to be dynamically searched. In IM conversation 502, an IM communication exchange is displayed between two users. Each user, local user 520 and remote user 524 may provide communication in respective message entry 504 of respective IM clients. Selected text 523 may be automatically selected (according to the keyword/term selection functionality of IMPS utility) to identify a search topic. In another embodiment, the local user may manually select the selected text 523. When selected text 523 is chosen by local user 520, search web button 516 may be engaged to generate an immediate search utilizing selected text as the topic of the search.

In one embodiment, IMPS utility 140 may dynamically retrieve content within IM conversation 502, such as one or more proper names, nouns, and other terms, to utilize as search topics. The content is utilized in a dynamic, real-time search which may yield results displayed within search toolbox 508. When local user (520) is not interested in viewing results from the search, turnoff search selection 527 maybe chosen, which deactivates the functionality of IMPS utility which provides automatic/dynamic searching of keywords/terms.

In one embodiment, IMPS utility 140 retrieves information inputted into create profile GUI 300 (FIG. 3). The information entered into the various entries of the create profile GUI contains content that may be utilized as a search topic. When local user 520 begins an IM session with remote user 524, the contact profile information for remote user 524 is dynamically retrieved. The dynamically retrieved profile information is parsed for content that may be utilized as search topic(s) in a database and/or network search. The information acquired from the database and/or network search is then displayed in search toolbox 508. A search for the information displayed in search toolbox 508 may be initiated when the contact is selected, either before, after, and/or during the IM session. Information retrieved, such as provided by results of search 510, is displayed in real-time.

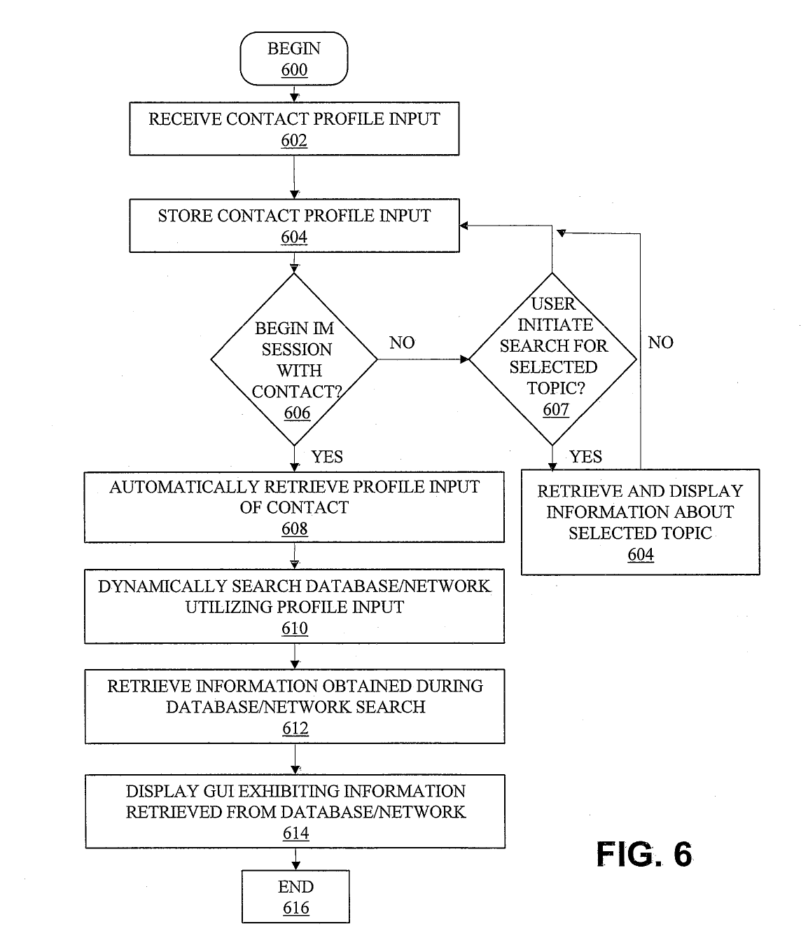

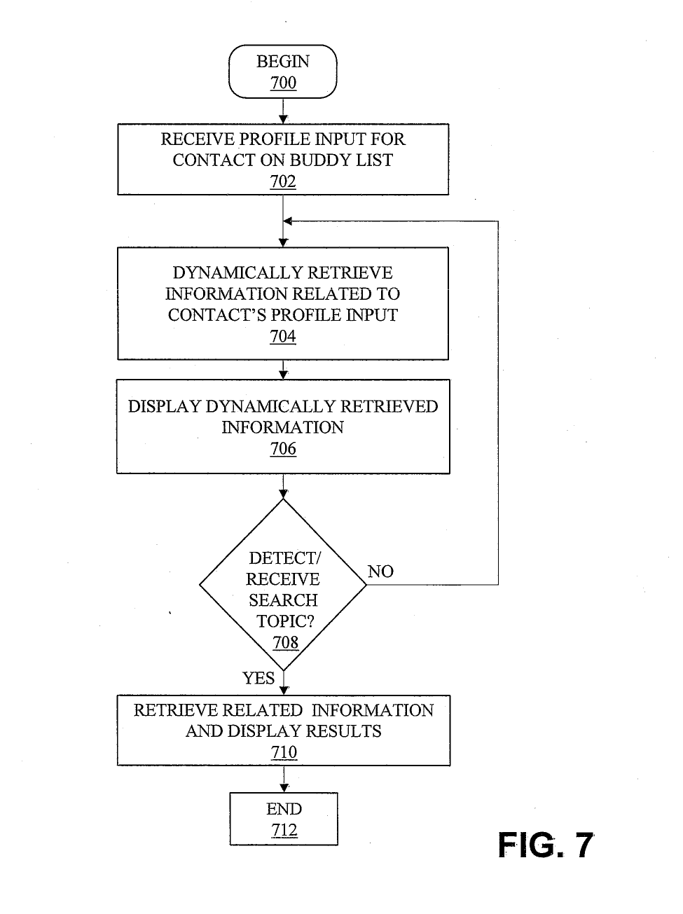

FIGS. 6-7 are flow charts illustrating various methods by which the processes of the illustrative embodiments are completed. Specifically, FIG. 6 describes the method of initiating a search for a subject selected from topics (or keywords) in an IM contact's profile and dynamically searching a database and/or network utilizing search terms retrieved from entries provided in create profile GUI 300. FIG. 7 describes the method for dynamically retrieving information related to a current topic of discussion during an ongoing IM session. Although the methods illustrated in FIGS. 6-7 may be described with reference to components shown in FIGS. 1-5, it should be understood that this is merely for convenience and alternative components and/or configurations thereof can be employed when implementing the various methods. Key portions of the methods may be completed by IMPS utility 140 and IM client 145 executing within DPS 100 (FIG. 1) and controlling specific operations of DPS 100, and the methods are thus described from the perspective of both IMPS utility 145 and IM client 140.

The process of FIG. 6 begins at initiator block 600, and continues to block 602 at which profile input for a contact is received (inputted by a user) within create profile GUI 300 (FIG. 3) by IMPS utility 140 (FIG. 1). At block 604 the received profile input is stored. A decision is made at block 606 whether an IM session is initiated with an IM contact. If an IM session is initiated with an IM contact, the process continues to block 608. If an IM session is not initiated, a next determination is made at decision block 607, whether the local user initiates a search of a selected topic corresponding to a selected contact within the social networking GUI 400 (FIG. 4). If the local user initiates this search, the IMPS utility access the network/database, conducts the search and retrieves information related to the selected topic, as shown at block 609. The additional information is also displayed to the local user. In one embodiment, the IMPS utility enables the local user to update the profile of the contact, if desired with the newly retrieved information.

Returning to block 608, once the IM session is initiated with the contact, the profile input for the contact is automatically retrieved and displayed. Also, when as provided at block 609, the IM session is preceded by a retrieval of additional information about a selected topic, the additional information is also displayed to the local user. With the profile input retrieved, the IMPS utility detects important content from the profile input, and dynamically initiates a search of a database and/or network utilizing the content detected from the profile input, as shown at block 610. At block 612, information found from searching the database and/or network using the detected content as a search topic is retrieved by IMPS utility 140. A GUI exhibiting the information retrieved by the search(es) is displayed along with the messaging/conversation box and message entry box (FIG. 5), at block 614. The process ends at block 616.

Turning now to FIG. 7, in which the IM client 140 is already in use on DPS 100, and search toolbox 508 is open on IM GUI 500 when the process begins at initiator block 700. The process proceeds to block 702, at which profile input for a contact within contact list 402 (FIG. 4) is received (from the contact's IM client) at the commencement of or during an IM session between the contact and the local user. The receipt or exchange of profile information may be permitted when an option to share specific types of profile information is turned on. At block 704, IMPS utility dynamically initiates a retrieval of information related to select content within the contact's profile input, and the information that is dynamically retrieved by the IMPS utility (140) is displayed at block 706. A decision is made at block 708 whether a subsequent search topic has been detected and/or received. The search topic may be detected from within an IM conversation 502 (FIG. 5) and/or input into keyword search entry 517 (FIG. 5). The detection method (in which searchable content is detected the IM conversation) may be initiated when a feature that enables real-time content searches is turned on (or an off feature is not selected) within the IM GUI. If no search topic is detected/received or the search function is turned off, the process returns to block 704. If a search topic is detected/received, the IMPS utility utilizes the search topic to conduct a search of the database/network and retrieves information related to the search topic, as provided at block 710. The retrieved information is also displayed within search GUI 508 (FIG. 5). The process ends at block 712.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Generally, the above illustrated and described embodiments provide a method implemented on a computer device connected to an information resource, such as a database and a network, on which information about a plurality of topics may be retrieved. The method includes: enabling creation of a contact profile for an instant messaging (IM) contact within an IM client application of a local user, wherein the contact profile includes content that is searchable; automatically retrieving from the content of the contact profile one or more search topics that may be utilized to conduct a search for related information on the information resource; in response to receiving a selection of a particular contact within a buddy list of the local user: retrieving and displaying a list of topics of interest to the particular selected contact; and in further response to a selection of one or more topics from the list of topics displayed, conducting a search for the information resource to retrieve information related to the selected one or more topics from the list of topics. The method further includes: in response to detecting an initiation of an IM session with the IM contact, dynamically conducting the automatically retrieving of the one or more search topics to performing the search of the network; initiating the search and retrieving the information found on the information resource related to the one or more search topics; displaying the information retrieved on the IM client to enable access to the information by the local user during the IM session; and enabling one or automatic updating of the contact profile or a local user update of the contact profile with information retrieved from the information resource.

Another embodiment of the above illustrated and described embodiments provide a method performed on a computer device that connects to an information resource, such as a database or a network, on which information about a plurality of topics may be retrieved. The method includes: initiating an instant messaging (IM) session on an IM client between a local user and a IM contact of the local user; tracking an exchange of communication between the IM contact and the local user; automatically detecting specific keywords and terms within the exchange of communication in real-time; and providing the specific keywords and terms as search topics to a searching facility associated with the IM client on which the IM session is being conducted. The method further includes: forwarding the search topics to the information resource to conduct a search for information related to the search topics; receiving search results from the information resource with information related to the search topics; and displaying the search results on the IM client, whereby the local user is provided, in real-time, additional knowledge information associated with the keywords and terms within the exchange of communication.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. On a computer device having a mechanism for connecting to an information resource such as a database and a network on which information about a plurality of topics may be retrieved, a method comprising:
enabling creation of a contact profile for an instant messaging (IM) contact within an IM client application of a local user, wherein the contact profile includes content that is searchable;
automatically retrieving from the content of the contact profile one or more search topics that may be utilized to conduct a search for related information on the information resource;
in response to receiving a selection of a particular contact within a buddy list of the local user:
retrieving and displaying a list of topics of interest to the particular selected contact; and
in further response to a selection of one or more topics from the list of topics displayed, conducting a search for the information resource to retrieve information related to the selected one or more topics from the list of topics;
in response to detecting an initiation of an IM session with the IM contact, dynamically conducting the automatically retrieving of the one or more search topics to performing the search of the network;
initiating the search and retrieving the information found on the information resource related to the one or more search topics;
displaying the information retrieved on the IM client to enable access to the information by the local user during the IM session; and
enabling one or automatic updating of the contact profile or a local user update of the contact profile with information retrieved from the information resource.

2. The method of claim 1, further comprising:
receiving a selection of content within a transcript of an electronic communication, wherein the content includes one or more words;
automatically searching the information resource using the selected content from within the transcript as the search topic; and
retrieving and presenting information from the information resource related to the selected content in real-time during the electronic communication.

3. The method of claim 1, further comprising:
automatically displaying a graphical user interface to exhibit the information retrieved from the information resource, wherein the information exhibited includes one or more of: a website link, a news clipping, a news headline, a news sound bite, and a news video, text-base content, graphics-based content, audio-based content, statistics, and reports.

4. A computer program product comprising:
a computer readable medium; and
program code on the computer readable medium that when executed by a processing device within a network-connected system, which connects to an information resource such as a database and a network on which information may be retrieved, the program code provides the functions of:
enabling creation of a contact profile for an instant messaging (IM) contact within an IM client application of a local user, wherein the contact profile includes content that is searchable;
automatically retrieving from the content of the contact profile one or more search topics that may be utilized to conduct a search for related information on the information resource;
in response to receiving a selection of a particular contact within a buddy list of the local user:
retrieving and displaying a list of topics of interest to the particular selected contact; and
in further response to a selection of one or more topics from the list of topics displayed, conducting a search for the information resource to retrieve information related to the selected one or more topics from the list of topics;
in response to detecting an initiation of an IM session with the IM contact, dynamically conducting the automatically retrieving of the one or more search topics to performing the search of the network;
initiating the search and retrieving the information found on the information resource related to the one or more search topics;
displaying the information retrieved on the IM client to enable access to the information by the local user during the IM session; and
enabling one or automatic updating of the contact profile or a local user update of the contact profile with information retrieved from the information resource.

5. The computer program product of claim 4, said program code further comprising code for:
receiving a selection of content within a transcript of an electronic communication, wherein the content includes one or more words;
automatically searching the information resource using the selected content from within the transcript as the search topic; and
retrieving and presenting information from the information resource related to the selected content in real-time during the electronic communication.

6. The computer program product of claim 4, said program code further comprising code for automatically displaying a graphical user interface to exhibit the information retrieved from the information resource, wherein the information exhibited includes one or more of: a website link, a news clipping, a news headline, a news sound bite, and a news video, text-base content, graphics-based content, audio-based content, statistics, and reports.

7. A communication device comprising:
a processor; and
a mechanism for communicatively connecting the device to an external network, including an information resource such as a database or a network on which information may be retrieved;
a memory having program instructions that when executed by the processor provides the functions of:
enabling creation of a contact profile for an instant messaging (IM) contact within an IM client application of a local user, wherein the contact profile includes content that is searchable;
automatically retrieving from the content of the contact profile one or more search topics that may be utilized to conduct a search for related information on the information resource;
in response to receiving a selection of a particular contact within a buddy list of the local user:
retrieving and displaying a list of topics of interest to the particular selected contact; and
in further response to a selection of one or more topics from the list of topics displayed, conducting a search for the information resource to retrieve information related to the selected one or more topics from the list of topics;
in response to detecting an initiation of an IM session with the IM contact, dynamically conducting the automatically retrieving of the one or more search topics to performing the search of the network;
initiating the search and retrieving the information found on the information resource related to the one or more search topics;
displaying the information retrieved on the IM client to enable access to the information by the local user during the IM session; and
enabling one or automatic updating of the contact profile or a local user update of the contact profile with information retrieved from the information resource.

8. The communication device of claim 7, wherein said program instructions further comprises instructions for:
receiving a selection of content within a transcript of an electronic communication, wherein the content includes one or more words;
automatically searching the information resource using the selected content from within the transcript as the search topic; and
retrieving and presenting information from the information resource related to the selected content in real-time during the electronic communication.

9. The communication device of claim 7, wherein said program code further comprises program instructions for automatically displaying a graphical user interface to exhibit the information retrieved from the information resource, wherein the information exhibited includes one or more of: a website link, a news clipping, a news headline, a news sound bite, and a news video, text-base content, graphics-based content, audio-based content, statistics, and reports.
